(19) United States
(12) Patent Application Publication
(10) Pub. No.: US 2013/0085887 A1
(43) Pub. Date: Apr. 4, 2013

(54) METHOD AND SYSTEM FOR FINANCIAL CARD TRANSACTION VERIFICATION

(71) Applicant: Wei Zhang, Newtown, PA (US)

(72) Inventor: Wei Zhang, Newtown, PA (US)

(21) Appl. No.: 13/269,529

(22) Filed: Oct. 7, 2011

Related U.S. Application Data
(60) Provisional application No. 61/542,387, filed on Oct. 3, 2011.

(51) Int. Cl. G06Q 30/06; G06K 7/01; G06F 17/00

(52) U.S. Cl. 705/26.8; 235/375; 340/10.1

(57) ABSTRACT

The invention is aimed to verify credit card transaction or any transaction using similar payment mechanism through joint effort of cardholder and card issuer. In accordance with the invention, principle of method to verify financial card transaction is to use a mobile communication device (MCD) carried by cardholder to maintain an event record in a record list every time when cardholder starts a payment using a financial card, then, having wireless communication network address of the MCD in account record associated with the financial card, account server of corresponding card issuer notifies the MCD a newly occurred activity regarding to payment transaction upon the account, after that, the MCD searches the record list trying to establish a match between the newly received activity notice and an existing event record that both the event record and the notice have substantially simultaneous occurring time, thus being considered for the same transaction.

### CROSS-REFERENCE TO RELATED APPLICATIONS

The present application claims the benefit of U.S. Provisional Application Ser. No. 61/542,387 filed by Wei Zhang on Oct. 3, 2011 and titled “Method and System For Financial Card Transaction Verification”, which is incorporated herein by reference.

### STATEMENT REGARDING FEDERALLY SPONSORED RESEARCH OR DEVELOPMENT

Not applicable.

### FIELD OF THE INVENTION

The present invention relates to method and system for verifying transaction authenticity, and in particular, to method and system of using mobile communication device to verify transaction authenticity.

### BACKGROUND OF THE INVENTION

Although credit card or other financial card has payment of purchase completed in a convenient and fast way, credit card fraud, a broad term referring to illegitimate use of credit card or other similar financial card or any similar payment mechanism, has been a long existing concern for cardholder, merchant, and financial institute such as bank, credit union or the like, which issues financial card to cardholder. When a fraud occurs on an account associated with financial card, in most case, either merchant who accepts the card or financial institute issuing the compromised card eventually bears loss caused by the fraud. However, no matter who bears the loss, it always makes cardholder or customer less willing to use credit card or similar financial card in afraid of causing fraud. Furthermore, while putting tremendous effort to prevent a fraud such as implementing sophisticate software to analyze whether an authorization request is likely a fraudulent charge, financial institutes are typically resistant to take complex measure to prevent credit card fraud because of their concern to intimidate cardholder or customer from using credit card or similar financial card for payment. Similarly, worrying to offend customer and lose potential sale, merchant is also reluctant to take extra measure such as to check ID of a suspicious card user appearing to be cardholder or ask more information thereof. Online merchant, in face of intense competition of online business, doesn't want to drive online shopper away by implementing complex payment procedure. Therefore, it demands a transaction verification method for payment using credit card or similar financial card, which should be accurate and hassle-free to cardholder or customer.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

The invention is aimed to verify credit card transaction or any transaction using similar payment mechanism through joint effort of cardholder and card issuer. Cardholder refers to an entity that legitimately owns or is authorized to use a financial card such as credit card, debit card, or the like or a financial account supporting the similar payment mechanism. Card issuer, typically a financial institute such as bank, credit union, or the like, refers to any entity that issues a financial card such as credit card, debit card or the like or a financial account supporting the similar payment mechanism and is responsible to manage account and transaction thereof. In order to promote usage, such verification should not require cardholder to intervene much in operation, thus being hassle-free to cardholder. For financial institutes managing transaction and associated account, such verification must be fast and accurate in order for them to take appropriate action to avert loss or damage possibly caused by a fraud. Thus, computer related technology and reliable communication are relied upon to fulfill the aim. In effect, such verification may thwart a criminal planner or theft possessing a stolen card or counterfeit card or account information associated to an authorized card or account to commit an actual fraud, meanwhile, build stronger confidence in cardholder to pay with financial card without worrying about possible card fraud.

It is to be recognized by ordinary skilled in the art that the method and system disclosed herein is applicable but not limited to credit card, debit card, or the like, or any financial account using the similar payment mechanism unless explicitly stated otherwise. Furthermore, it is to be understood that card-not-present transaction, such as online order or mail order or the like, permits a financial account without association to any actual card to be used for payment similarly as a credit card if the account is authorized to do so. Furthermore, it is foreseeable and understood that virtual card associated with a financial account may be used not only for card-not-present transaction but also for point-of-sale for payment processed in similar way as credit card. Such virtual card or the similar payment mechanism is considered to be within applicable scope of the method and system disclosed in the disclosure in accordance with the invention. In this disclosure, term “financial card” refers to credit card, debit card, or the like, or any financial account using the similar payment mechanism. In some circumstances, term “credit card” is used, as well, to represent credit card, debit card, or the like, or any financial account using the similar payment mechanism, because meaning and authorizing process of credit card is widely known such that it facilitates better understanding of the disclosure.

In accordance with the invention, the principle of method to verify financial card transaction is to use a mobile communication device (MCD) carried by cardholder to maintain an event record in a record list every time when cardholder starts a payment using a financial card, then, having wireless communication network address of the MCD in account record associated with the financial card, account server of corresponding card issuer notifies the MCD a newly occurred activity regarding to payment transaction upon the account, after that, the MCD searches the record list of event records trying to establish a match between the newly received activity notice and an existing event record that both the event record and the notice have substantially simultaneous occurring time, thus being considered for the same transaction. In addition to substantially simultaneous occurring time, information such as GPS location of the MCD, store location, or transaction amount may be used accordingly as secondary evidence to further enhance accuracy of matching. When a match is successfully established, the account activity related to the notice is considered to be started by authorized cardholder. When a match is not established, the MCD may immediately prompt cardholder to be aware of possible fraud occurring on cardholder's account for taking appropriate action, and, upon cardholder's preference, automatically alert the account server through wireless communication network for card issuer to take best action on related issue. No matter whether a match is established or not, the MCD can automatically send searching result to the account server or do so upon user's preference. Card issuer has a variety of ways to take advantages from the method. One way is to process card transaction as usual and use the searching result sent from the MCD as post-transaction verification. Another way is to hold authorization of payment request until receiving the searching result from the MCD, then, authorize the request if a successful match is established by the MCD, or, disapprove the request or take extra safety measure to verify the request if a match is not established by the MCD.

In accordance with the invention, one embodiment of method to verify financial card transaction uses a financial card embodying a RF identification circuitry, when the card is applied by cardholder on a card reader for payment transaction, to send out a RF signal having encoded thereon with an identification associated with the card. A mobile communication device (MCD) carried with cardholder is to receive the RF signal and process thereof to obtain the identification. An event record coupled with the identification is then generated by the MCD. The event record at least includes a time data of the time that the RF signal is received by the MCD according to internal clock of the MCD. The event record is preserved in a record list for transaction verification. When the MCD receives a notice regarding to newly occurred activity on account associated with a financial card sent by account sever of card issuer, which is coupled with card processing server, the MCD processes the received notice to obtain at least an account identifier associated with the account and a time date of the time that the request of noticed activity is received by the processing server according to internal clock of the server. Then, the MCD searches the record list to find a match between the notice with an event record of the record list that both of them have substantially the same time data regarding to occurring times of receiving the RF signal and receiving the request of notice activity. Additional information such as GPS location of the MCD, store location, or transaction amount may be used accordingly as secondary evidence to further enhance accuracy of matching. The MCD responds to the account server or notifies cardholder accordingly upon matching result after searching of match is finished. It is preferred that cardholder is only notified when a match is not established.

In accordance with the invention, another embodiment of method to verify financial card transaction is to use a RF emitter adapter connected to internal bus or I/O bus of a computer, which, once receiving a control signal from the bus, set forth a RF signal having encoded thereon at least an identification associated to a financial card used for purchase payment. A software application executed by the computer to support the payment may signal the adapter to set forth the RF signal immediately after order with account information of the financial card for payment is transmitted to order server for officially placing the order. Alternatively, the software application may signal the adapter to set forth the RF signal immediately after receiving confirmation of order submission from the order server. Then, the RF signal is received by a mobile communication device (MCD) carried with cardholder when placing the order. The MCD processes the received RF signal to obtain the identification associated with the card. An event record coupled with the identification is then generated by the MCD. The event record at least includes a time data of the time that the RF signal is received by the MCD according to internal clock of the MCD. The event record is preserved in a record list for transaction verification. When the MCD receives a notice regarding to newly occurred activity on account associated with a financial card sent by account sever of card issuer, which is coupled with card processing server, the MCD processes the received notice to obtain at least an account identifier associated with the account and a time date of the time that the request of noticed activity is received by the processing server according to internal clock of the server. Then, the MCD searches the record list to find a match between the notice with an event record of the record list that both of them have substantially the same time data regarding to occurring times of receiving the RF signal and receiving the request of notice activity. Additional information such as GPS location of the MCD, store location, or transaction amount may be used accordingly as secondary evidence to further enhance accuracy of matching. The MCD responds to the account server or notifies cardholder accordingly upon matching result after searching of match is finished. It is preferred that cardholder is only notified when a match is not established.

In accordance with the invention, another embodiment of method to verify financial card transaction is to generate and show on display screen by a software application executed by a computer for supporting ordering a data encoded pattern having encoded thereon at least an identification associated with a financial card used for payment of an order and a time date of the time that the order with account information of the financial card is transmitted or is to be transmitted to order server for officially placing the order. An image of the displayed data encoded pattern is then captured by a mobile communication device (MCD) using onboard camera. The MCD processes the captured image of the data encoded pattern to obtain at least the identification and the time date. Then, the MCD generates an event record coupled with the identification that at least includes the time data. The event record is preserved in a record list for transaction verification. When the MCD receives a notice regarding to newly occurred activity on account associated with a financial card sent by account sever of card issuer, which is coupled with card processing server, the MCD processes the received notice to obtain at least an account identifier associated with the account and a time date of the time that the request of noticed activity is received by the processing server according to internal clock of the server. Then, the MCD searches the record list to find a match between the notice with an event record of the record list that both of them have substantially the same time data regarding to occurring times of receiving the RF signal and receiving the request of notice activity. Additional information such as GPS location of the MCD, store location, or transaction amount may be used accordingly as secondary evidence to further enhance accuracy of matching. The MCD responds to the account server or notifies cardholder accordingly upon matching result after searching of match is finished. It is preferred that cardholder is only notified when a match is not established.

In accordance with the invention, the disclosure includes systems to carry on embodiments of method to verify financial card transaction. The system and component units thereof or software applications thereof are apparently within the scope of the invention.

In accordance with the invention, above description of summary is best effort to fulfill purpose or need of Brief Summary of Invention section and should not be used for purpose to reduce or be against merits of the invention as a whole. Furthermore, not to be limited by this summary section, all patentable rights embodied in or derived from the complete disclosure are reserved without prejudice.

### BRIEF DESCRIPTION OF THE SEVERAL VIEWS OF THE DRAWINGS

It should be understood that the brief description of the several views of the drawings is only for the purpose of presenting a concise reference to accompanying drawings and should not be inferred to have any suggestion to limit or reduce the scope of invention. Furthermore, the concepts and embodiments of the invention explicitly or implicitly shown in the drawings are only possibly understood accordingly by referring to following detailed descriptions upon illustrative showings of the drawings. For illustrative purpose, the drawings are not in scale. In the drawings:

FIG. 1 illustratively shows overview of one embodiment of method and system for financial card transaction.

FIGS. 2 and 3 are process flowchart illustratively showing the method of the embodiment according to illustrative showing of FIG. 1.

FIGS. 4A, 4B, 4C, and 4D illustratively show a variety of embodiments of financial card embodying RF identification circuitry useful for method and system for financial card transaction verification.

FIG. 5 illustratively shows overview of one embodiment of method and system for financial card transaction.

FIG. 6 is process flowchart illustratively showing event record generation portion of the method of the embodiment according to illustrative showing of FIG. 5.

FIGS. 7A and 7B illustratively show a variety of embodiments of RF emitter adapter connected to I/O bus or internal bus of the computer for online ordering, which is useful for method and system for financial card transaction verification.

FIG. 8 illustratively shows overview of one embodiment of method and system for financial card transaction.

FIG. 9 and FIG. 10 are process flowcharts illustratively showing event record generation portion of the method of the embodiment according to illustrative showing of FIG. 8.

FIG. 11 illustratively gives several examples of data encoded pattern which is useful for method and system for financial card transaction verification.

### DETAILED DESCRIPTION

In accordance with the invention, one embodiment of method to verify financial card transaction uses a financial card embodying a RF identification circuitry, when the card is applied by cardholder on a card reader for payment transaction, to send out a RF signal having encoded thereon with an identification associated with the card. A mobile communication device (MCD) carried with cardholder is to receive the RF signal and process thereof to obtain the identification. An event record coupled with the identification is then generated by the MCD. The event record at least includes a time data of the time that the RF signal is received by the MCD according to internal clock of the MCD. The event record is preserved in a record list for transaction verification. When the MCD receives a notice regarding to newly occurred activity on account associated with a financial card sent by account sever of card issuer, which is coupled with card processing server, the MCD processes the received notice to obtain at least an account identifier associated with the account and a time date of the time that the request of noticed activity is received by the processing server according to internal clock of the server. Then, the MCD searches the record list to find a match between the notice with an event record of the record list that both of them have substantially the same time data regarding to occurring times of receiving the RF signal and receiving the request of notice activity. Additional information such as GPS location of the MCD, store location, or transaction amount may be used accordingly as secondary evidence to further enhance accuracy of matching. The MCD responds to the account server or notifies cardholder accordingly upon matching result after searching of match is finished. It is preferred that cardholder is only notified when a match is not established.

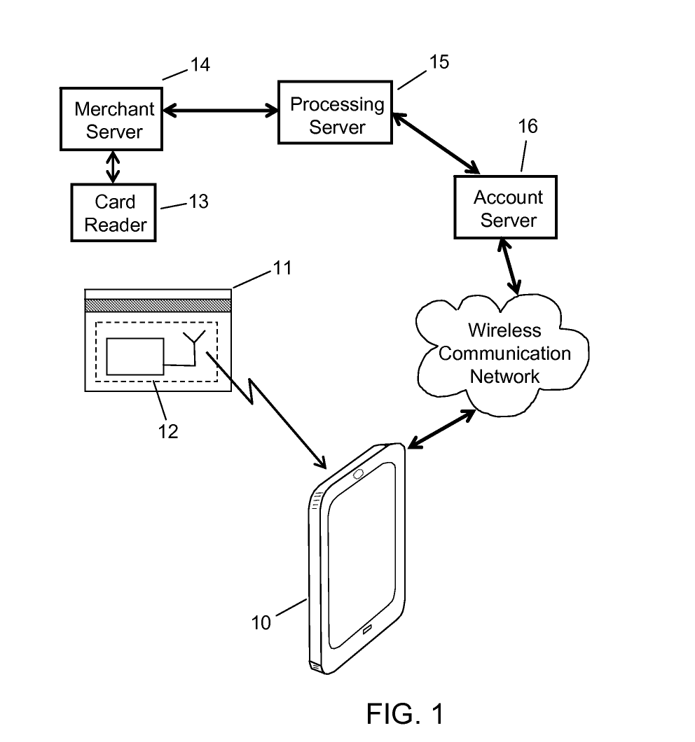

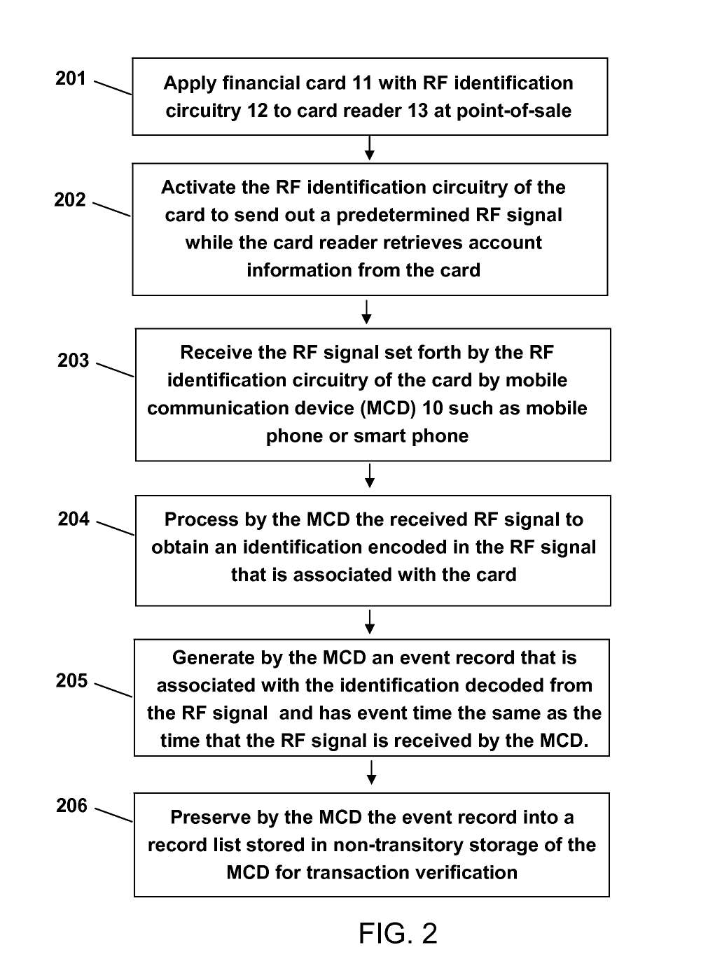

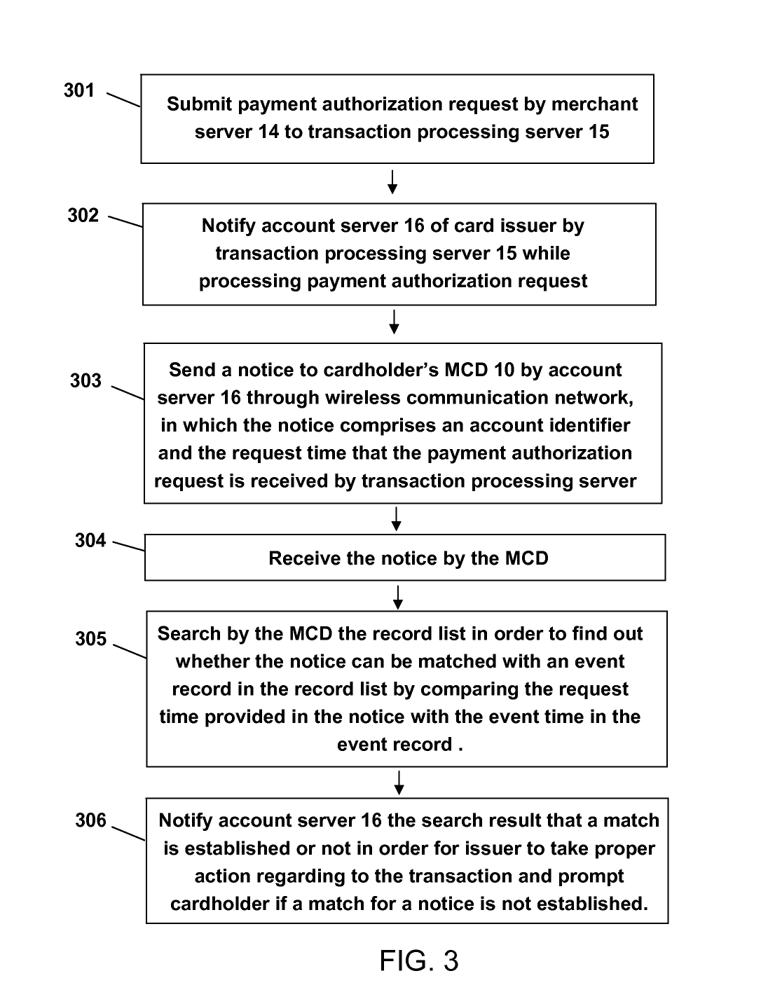

In accordance with the invention, an system to carry on the above embodiment of method to verify financial card transaction is illustratively shown in FIG. 1, and, the embodiment of the method is better recognized by referring to process flowchart illustratively given in FIG. 2 and FIG. 3. According to the drawing of FIG. 1, a financial card 11 embodying RF identification circuitry 12 is applied on card reader 13 by cardholder to start a payment transaction, also illustratively given as step 201 of FIG. 2. For example, typical scenario is to swipe a credit card on a card reader at supermarket or store. When financial card 11 is applied on card reader 13, card reader 13 retrieves account information associated with financial card 11 therefrom through either magnetic strip swiping or non-contact near field communication (NFC).

Approximately simultaneously, RF identification circuitry 12 is activated directly or indirectly by card reader 13 to set forth a RF signal, illustratively given as step 202 of FIG. 2. The RF signal is predetermined to have encoded thereon an identification associated with financial card 11. Circuitry 12 may be either passive or active. Passive RF identification circuitry relies on external activation signal pulse to transfers electromagnetic energy into the circuitry to power up RF emission thereof. Active RF identification circuitry has onboard power source, which may be a battery or light electricity converter such as solar panel. It is apparent for ordinary skilled in the field to recognize that passive RF identification circuitry is preferred for purpose herein. Passive RF identification circuitry is generally similar to RFID tags widely used for merchandise, transportation, door entry card and so on, but dedicated for the purpose that its emitted RF signal is receivable by a mobile communication device (MCD) located within range of several meters. For common store context of checkout counter, the receivable range of the RF signal is preferred to be from 0.3 meters to 2 meters. For safety concern on transmitted information, the receivable range is better limited to sufficient for MCD carried with cardholder to receive the RF signal. It is possible that the receivable range is adjusted by varying intensity and time duration of activation signal pulse, which transfers electromagnetic energy into the RF identification circuitry to power RF emission thereof. Although active RF identification circuitry is not as suitable for purpose herein as passive RF identification circuitry, it may be used if cost of making is not concerned and the above teaching about RF signal receivable range is useful for active RF identification circuitry as well.

The RF signal emitted by financial card 11 is then received by a mobile communication device 10 (MCD) carried with cardholder, illustratively given as step 203 of FIG. 2. The mobile communication device necessarily has RF receiver capable of receiving RF signal thereof. It is possible that the RF identification circuitry is designed to have RF frequency within receiving frequency range of wireless communication circuitry already existed on the mobile communication device. Thus, a dedicated RF receiver for purpose hereof is not necessary to be added thereon. Otherwise, the mobile communication device has to have a RF receiver dedicated to receive the RF signal. Therefore, implementation may be a compromise between complexity and cost of RF identification circuitry on financial card and induced cost of receiving RF signal thereof on mobile communication device. Term “mobile communication device” refers to any portable or handheld computing device designed or used to be connected to regional or national or worldwide wireless communication network such as cellular phone network, 3G or 4G wireless network, Wi-Fi wireless network, satellite network, or the like. The communication capability desired for mobile communication device (MCD) herein is that the MCD can be wirelessly reached for data transfer at as many as possible useful locations within area where cardholder normally stays. Any mobile or handheld computing device or the like having the desired communication capability may be useful for the method or system herein, thus fallen into meaning of term “mobile communication device” herein. Common mobile communication devices include cell phone or mobile phone or smart phone, PDA (Personal Digital Assistant), tablet computer such as Apple i-Pad or the like, E-reader, some GPS navigation devices, and portable computer. Among these devices, mobile phone or smart phone is the most suitable device to be used for implementing method of financial card transaction verification in accordance with the invention, because it is getting more and more routine and popular for people to carry a mobile phone or smart phone for daily activities. Smart phone, for example such as i-Phone and Android phone, has sufficient computing power and storage to meet the need of the implementation.

The received RF signal is then processed accordingly by the mobile communication device (MCD) to obtain the identification associated with the financial card, illustratively given as step 204 of FIG. 2. If more information had been encoded in the RF signal, the information is to be obtained as well. The MCD also determines the time that the RF signal is received. There are a variety way to achieve that. One way is to record the time, according to internal clock of the MCD, by the software driver to control the RF receiver receiving the RF signal. Another way is to record the time by the control circuit of the RF receiver. Another way is to couple an internal time signal inside circuitry of receiver with the received RF signal, which then are processed to determine the time. Another way is to determine the time by operating system of the MCD, which may be as accurate as other ways if operating system runs fast enough. After that, an event record corresponding to the transaction is generated by the mobile communication device, illustratively given as step 205 of FIG. 2. The event record is coupled with the identification obtained from step 204 and at least includes a time data of the time that the RF signal is received by the MCD. It is emphasized that the time that the RF signal is received is determined by the MCD according to its own clock. The clock of MCD may be constantly calibrated according to time signal retrieved from wireless communication network or time signal decoded from GPS signals or any way to make it more accurate. The time data of the event record is viewed by the MCD as event time for related transaction. After that, the event record is preserved in a record list, which contains all event records generated accordingly, for transaction verification, illustratively given as step 206 of FIG. 2. The record list contains event records already generated accordingly. It may further contain updated status of event record such as whether the event record has already been matched with a previously received notice. The record list may be in any form of database or any form making it searchable and manageable. Event record coupled with the identification associated with specific financial card can be retrieved from the record list, just like retrieving data from database or table. Each event record has its time date as primary evidence for transaction verification and may have other information as secondary evidence for transaction verification to enhance accuracy of verification.

In accordance with the invention, the above described portion of the method to verify financial card transaction, which is illustratively given as from step 201 to step 206 in FIG. 2, constitutes event record generation of the method. The event record generation of the method is essentially in the effort to have every transaction that is initiated by cardholder recorded through a secure way that is unlikely to be imitated or pretended to be authentic by a fraud transaction. It is often the case that victim cardholder does not realize his/her card has been stolen or account information of his/her card has been compromised until a fraud occurs. However, if a cell phone is lost or stolen, owner normally realizes that very soon simply because of high using frequency of cell phone. Thus, it is not easy or unlikely that criminal carrying on card fraud can get in control of cardholder's mobile phone or smart phone without tipping off cardholder. When a fraud using stolen card or forfeiture card occurs somewhere, there is not the related record in cardholder's mobile phone or smart phone unless the fraud transaction happens to be initialized substantially simultaneously as an authentic transaction initialized by true cardholder. Considering technical difficulty for a fraud criminal to assure to initialize a fraudulent transaction in time coincidence with an authentic transaction initialized by true cardholder, it is unlikely for the attempt of card fraud to achieve that. Furthermore, even though a fraud transaction does coincide with an authentic transaction, processing server processing card transaction or account server of card issuer would be immediately alerted that one of the two coincidence transactions must be a fraud because it is not possible for cardholder to simultaneously initialize two payment transactions at two different store locations.

Typically, when a credit card is applied on a card reader at merchant's site, account information of credit card is retrieved by card reader and the sent to merchant server handling payment. Merchant server submits an authorization request including the account information to processing server in charge of completing transaction. The processing server then notifies card issuer's server to inquire whether the transaction should be authorized. When card issuer's server confirms account valid and transaction within limit or agreement, the processing server continue to complete the transaction and then notifies merchant's server that the authorization request is approved and payment is credited. After that, merchant's server provides sale receipt to customer through a sale representative or automatic checkout machine. Similar transaction authorization procedure is used for debit card or other transactions using the similar payment mechanism.

According to FIG. 1, when financial card 11 is applied on card reader 13, account information of the card for payment is retrieved from the card. The account information is sent to merchant server 14 through in-store network. Merchant server submits payment authorization request with the account information to processing server 15 in charge of handling payment transaction, illustratively given as step 301 in FIG. 3. The transmission of payment authorization request is going through either internet or dedicated communication network for financial transaction. It is to be understood that some merchants may use a card reader that directly transmit payment authorization request to processing server, which is considered to be still applicable for the method hereof. Processing server 15 communicates with account server 16 to fulfill processing of the payment authorization request associated with financial card 11, illustratively given as step 302 in FIG. 3. Account server 16, typically belonging to card issuer, manages an account associated with the financial card either directly or indirectly through other server authorized to do so. The communication between processing server 15 and account server is normally through financial institute network which is secure and fast.

To complete transaction verification of the method, when an activity, such as payment authorization request, payment, or similar activity that is necessary to be verified, appears on an account associated with a financial card, account server 16 managing the account sends a notice through wireless communication network to cardholder's mobile communication device 10 (MCD), which has its wireless communication address set in account record of the account for the purpose. This step is illustratively given as step 303 in FIG. 3. The notice at least includes an account identifier associated with the account of the financial card and a time data of the time that the payment authorization request related to activity setting forth the notice is received by card issuer side including processing server and account server. It is to be understood that the time data is intended to be the time that payment authorization request is received by processing server, but, considering very fast communication between processing server and account sever, the time data may use the time that account server is notified by processing server for the activity providing insignificant or ignorable time delay involved therein. No matter which time is used, it has the same effect and works in the same way. Therefore, no matter which time is in use, the disclosure treats and views time data of a notice the same as or equivalent to the time that processing server receives authorization request related to activity setting forth the notice. Cryptographic communication may be used between the account server and the mobile communication device.

Once mobile communication device 10 (MCD) receives a notice from account server 16, the received notice is processed to obtain the account identifier and the time data contained by the notice. If other information is contained in the notice, it will be obtained accordingly too. Then, the MCD searches the record list which contains event records already generated by the MCD for transaction verification purpose to find out whether the notice can be matched with an event record associated with the same financial card as the account identifier such that they are reasonable considered to belong to same transaction. As illustratively given as step 305 in FIG. 3, a match between the notice and an event record associated with the same financial card is established only if the time data of the event record is substantially the same as the time data of the notice. The MCD relies on the identification received from the RF signal, which causes the event record to be generated by MCD, to tell with which financial card the event record is associated. A predetermined correlation between the identification and the account identifier is created in advance when setting up implementation of the method. There are a variety of ways to correlate the identification with the account identifier. For example, they may be just set the same. Or they are different, but having a linkage between them to tell whether they are linked to the same financial card. The time data of the event record is considered to be substantially the same as the time data of the notice if the time difference between the time data thereof is comparable to reasonable time delay normally occurring during payment processing procedure. The reasonable time delay includes delay of submitting payment authorization request by merchant server 14, delay of communication between merchant server 14 and processing server 15, and delay of processing server 15 to establish a receiving time for the authorization request. If the time data of the notice is the time that account server 16 receives activity coupled to the authorization request, the reasonable time delay may further include delay of communication between processing server 15 and account server 16 and delay of account sever 16 to establish a receiving time for the activity. A predetermined value corresponding to maximum allowable time delay for normal transaction processing procedure is used to compare with the time difference. When the time difference is within the predetermined value, the time data thereof are considered to be substantially the same as each other. For safety reason, the predetermined value should not be much larger than normal time delay of transaction processing procedure because the smaller the harder for a fraud to imitate. Considering state-of-art communication speed and transaction processing, a reasonable delay should be normally less than several seconds. Thus an example of the predetermined value may be 5 seconds, 10 seconds, 15 seconds or 20 seconds. Furthermore, it is possible to dynamically modify the predetermined value for time data comparison according to current delay occurring in transaction processing procedure, which requires account sever monitoring the delay keeps updating MCD the latest value. If other information, such as transaction amount or location, are both available for the notice and the event record, it may be used as secondary evidence to enhance accuracy of matching.

As illustratively given in step 306 in FIG. 3, mobile communication device 10 (MCD) may notify account server 16 the search result that a match for the notice is established or not in order for card issuer to take proper action regarding to the transaction and prompt card holder if a match for a notice is not established. The MCD may have communication address of account server 16 in local storage or obtain that from the notice received from the server. It is also possible that card issuer instruct the MCD to send searching result of matching to a different server designated to handle such issue, which herein is viewed and treated the same as, equivalent to or as extending portion of the account server. Cardholder may decide how the searching result is reported according to his/her preference. For example, cardholder may decide only searching result of no match established is reported to the account server. Or, cardholder may decide not sending searching result automatically but asking his/her permission before sending that. Of course, for sake of promoting transaction safety, it is preferred for letting the MCD automatically report searching result of matching to the account server. To avoid bothering cardholder with every transaction, it is preferred for letting the MCD prompt cardholder only if a match is not established for a received notice.

According to the invention, the above described portion of the method to verify financial card transaction corresponding to steps illustratively given as from step 301 to step 306 in FIG. 3 constitutes event-activity matching of the method. The event-activity matching of the method is essentially in the effort to use mobile communication device to verify transaction by comparing the time trigging an event record with the time initializing a payment authorization record. Principally, the advantageous features of the method are still retained if the MCD submits the event record to the account server or a third party server to fulfill comparison of time data to match an account activity with an event record, therefore falling into the spiritual scope of the invention. However, considering cardholder's privacy concern caused by such practice, it is not proffered comparing to let mobile communication device under cardholder's full control perform the transaction verification portion of the method.

Financial card 11 may be made by adding RF identification circuitry on a card containing necessary features that works with card reader in usual way. Typically, a magnetic stripe magnetically storing account information of financial card is present as main feature to work with swiping on card reader. Some financial cards further have chip and near field communication interface embodied for working with tapping or non-contacting on card reader. In accordance with the invention, it is to be understood that RF identification circuitry 12 on financial card 11 is intended to be received by MCD 10, not like the necessary features that provide account information to card reader. One-way communication from card 11 to MCD 10 through RF signal set forth by RF identification circuitry 12 is sufficient for purpose of the method hereof. But, setting aside cost issue, two-way communication between card 11 to MCD 10 is also workable for the purpose, thus within the scope of the invention disclosed herein.

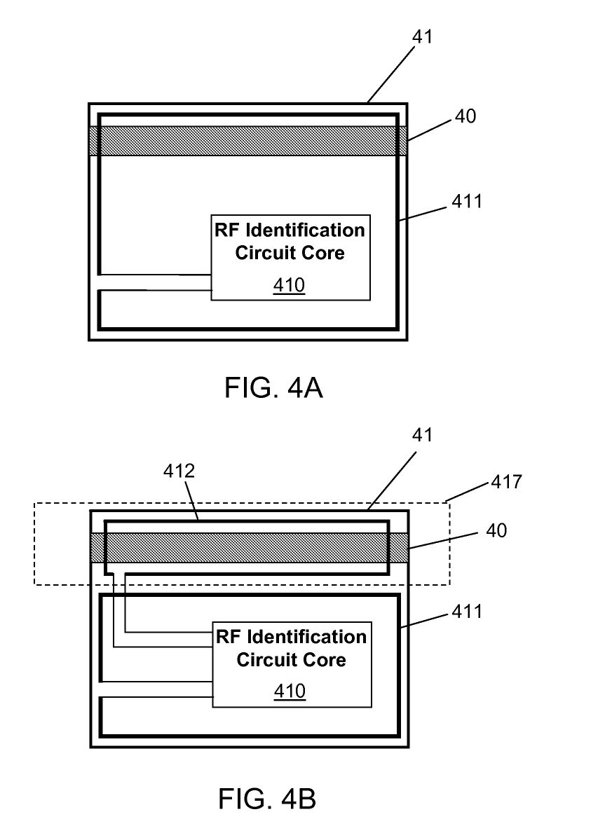

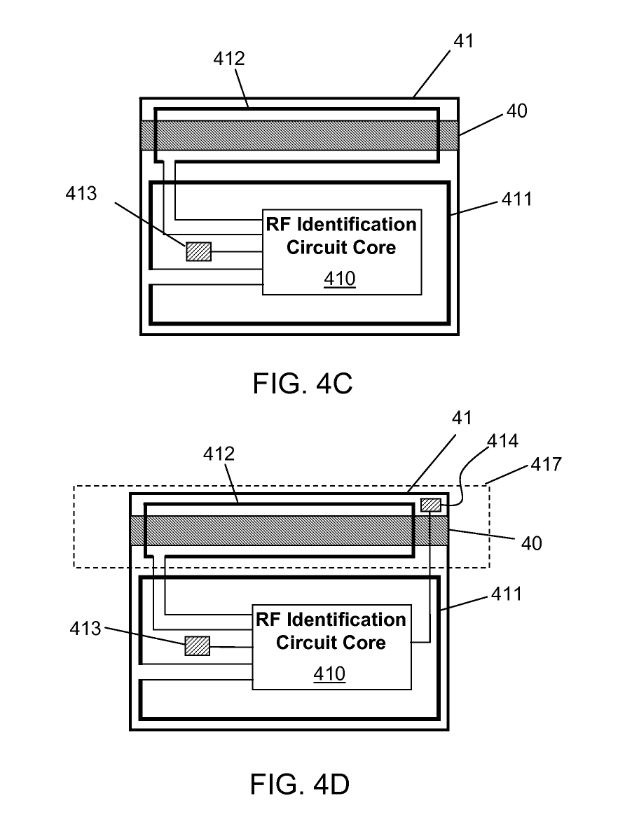

FIG. 4A illustratively shows an embodiment of financial card 11. Magnetic strip 40 is located close to edge of one side of card plate 41, which is typically made of plastic. The RF identification circuitry embodied by card plate 41 comprises a circuit core 410 and a antenna 411. Antenna 411 receives activation signal either directly from card read or from another RF source coupled to card reader. The activation signal transfers energy into antenna 411 to power up circuit core 410. Circuit core 410 has a data storage that store predetermined information such as an identification associated with the financial card. Upon energized, circuit core 410 responds accordingly to set forth RF signal encoded with the predetermined information through antenna 411. To receive more energy from outside, antenna 411 is made very close to periphery of card plate 41, thus as large as possibly being accommodated by the plate.

FIG. 4B illustratively shows another embodiment of financial card 11. The RF identification circuitry embodied by card plate 41 comprises a loop coil 412, circuit core 410 and antenna 411. The RF identification circuitry uses loop coil 412 to receive activation signal to power up circuit core 410 and antenna 411 to emit RF signal as response from the circuit core. Thus, energizing core circuit 410 and emitting RF signal are through different features, thus permitting to activate the RF circuitry through resonant inductive coupling. Resonant inductive coupling transfers electrical energy through two adjacent magnetic loops each disposed in effective range of magnetic field of the other. Near field communication also uses the principle of resonant inductive coupling. In this embodiment of financial card 11, loop coil 412 is to work with another loop coil embodied by card read to receive activation signal through resonant inductive coupling. Because of near field nature of resonant inductive coupling, two loop coils should be very close to each other for effective energy transfer, typical within a range less than 1 centimeter and often just a few millimeters. For the reason, loop coil 412 is located inside the card area corresponding to card swiping region 417, which represents region of reading slot of card reader when the card is swiped on card reader. The other loop coils for resonant inductive coupling is located on sidewall of the reading slot of the card reader. When the card is swiped through the reading slot, the two loop coils will face to each other at a very close range less than the width of the reading slot which is typically only slightly larger than the card thickness. It is apparent that magnetic stripe 40 is located inside the card area corresponding to card swiping region 417 in order for card reader to read data stored in the magnetic stripe. In order to transfer energy more efficiently, loop coil 412 is made as large as possibly permitted, thus rendering a preferred rectangular shape with two longer sides enclosing or adjacent in one to one two side edges of magnetic stripe 40 and two shorter sides adjacent side edges of card plate 41. Comparing with the embodiment of financial card 11 illustrative shown in FIG. 4A, this embodiment of financial card 11 has following advantages: loop coil 412 for activation of the RF identification circuitry makes incorporating corresponding loop coil into card read easy and cheaper; near filed nature of resonant inductive coupling makes activation of the RF identification circuitry very reliable and secure. Furthermore, as an additional capability, loop coil 412 and corresponding loop coil on card reader may form near field communication interface, thus permitting card reader to control the RF circuitry to send the RF signal further encoded with transaction information such as payment amount, store code and et. al. to the MCD providing the RF circuit supporting such capability. It is to be understood that these additional transaction information is only used as secondary evidence to enhance accuracy of transaction verification.

There is common safety concern that RF identification circuitry may be activated by an unauthorized remote RF source for malicious purpose. To counter such attempt of unauthorized activation, an embodiment of financial card 11, as illustratively shown in FIG. 4C, has a light sensor 413 coupled in the RF identification circuitry the same as that contained by the embodiment illustratively shown in FIG. 4B. When light sensor 413 has no light incidence, RF emission of the RF identification circuitry is disabled. When light sensor 413 detects light exposure, RF emission of the RF identification circuitry is enabled. Thus, when cardholder places the card in wallet or pocket, the RF identification circuitry can not emit RF signal due to no light upon the light sensor. When cardholder takes the card out of wallet or pocket for payment use, RF emission of the RF identification circuitry is enabled since ambient light is upon the light sensor. Therefore, unauthorized activation on the RF identification circuitry of the card is prevented. There are a variety way to couple the light sensor into the RF identification circuitry. One way is to use output of the light sensor to turn on or off power input of circuit core 410. This can be achieved by insert a switch coupled to out put of the light sensor in connection line between loop coil 412 and circuit core 410 since circuit core 410 receives power from loop coil 412 during activation. Another way is to have a logic control implemented in circuit core 410, which either disables RF emission or encodes RF signal in a different or random way not recognizable by mobile communication device 10 if output of the light sensor indicates no light incidence thereon. Another way is to use output of the light sensor to disable read of the storage of circuit core 410, thus no identification associated with the card retrievable by the circuit core. In term of making, the light sensor may be a photodetector made by III-V semiconductor processing and then built into the RF identification circuitry. If circuit core 410 is an IC chip made on semiconductor substrate, it is possible to make the photodetector integratedly on the IC chip. The sensitivity requirement to the photodetector is not high. So, it is possible to use Silicon based photodetector for the light sensor, which can be easily integrated on Silicon IC chip. It is to be understood that, no matter how it is made and coupled into the RF identification circuitry, light sensor 413 is viewed as portion of the RF identification circuitry since its working manner and intended purpose is part of operation of the RF identification circuitry. It is recognized by ordinary skilled in related art that there are a variety of ways to arrange the light sensor eventually working as described in the embodiment. These ways to arrange the light sensor, even appearing no direct connection to the RF identification circuitry, are still within the scope of the embodiment and the light sensor is still viewed as portion of the RF identification circuitry for the same reason as above.

The existence of light sensor 413 dramatically reduces possibility of unauthorized activation of the RF identification circuitry on financial card 11. However, it is still possible for attempt of unauthorized activation to occur when cardholder happens to expose the card under light or take the card out for payment but not doing so immediately. To further enhance card safety against the unauthorized activation, another embodiment of financial card 11 is illustratively shown in FIG. 4D. The embodiment of financial card 11 has two light sensor coupled into the RF identification circuitry. One is light sensor 413, which is located outside the card area corresponding to card swiping region 417. The other one is light sensor 414, which is located inside the card area corresponding to card swiping region 417. Light sensor 413 in this embodiment works similar as in the embodiment illustratively shown in FIG. 4C. But, light sensor 414 works in an reverse way. When light sensor 414 has no light incidence thereupon, RF emission of the RF identification circuitry is enabled. When light sensor 414 has light incidence thereupon, RF emission of the RF identification circuitry is disabled. Light sensor 414 may be coupled to circuit core 410 in similar way as light sensor 413 does. By joint effect of both light sensor 413 and 414, RF emission of the RF identification is only enabled when light sensor 413 has light incidence thereupon and light sensor 414 has no light incidence thereupon. This corresponds to the scenario when cardholder swipes the card through reading slot of card reader. In the scenario, light sensor 413 unobstructed by the reading slot has ambient light incidence thereupon and light sensor 414 has no light incidence thereupon because light sensor 414 is obstructed by the reading slot of card reader. Thus, activation of the RF identification circuitry on the card is only achievable when the card is swiped through the reading slot of card reader. Therefore, unauthorized activation of the RF identification circuitry on the card is completely prevented even when cardholder takes the card out of wallet or pocket. In term of making, light sensor 414 may be made into the RF identification circuitry through similar way as light sensor 413, which is already described in immediately above paragraph. It is to be understood that, no matter how they are made and coupled into the RF identification circuitry, light sensor 413 and 414 are viewed as portion of the RF identification circuitry since their working manner and intended purpose are part of operation of the RF identification circuitry. It is recognized by ordinary skilled in related art that there are a variety of ways to arrange the light sensors eventually working as described in the embodiment. These ways to arrange the light sensors, even appearing no direct connection to the RF identification circuitry, are still within the scope of the embodiment and the light sensors are still viewed as portion of the RF identification circuitry for the same reason as above.

It is to be understood that the principle of using light sensor 413 and 414 as described above is useful for any card with RF identification circuitry to use light sensor or light sensors in similar way to counter against unauthorized activation of the RF identification circuitry. Basically, one light sensor tells whether the card is taken out of cardholder's wallet or pocket, and, if applicable, another light sensor tells whether the card is used on card reader or corresponding reading apparatus for normal use. Comparing other ways such as using internal battery for the circuitry or using cryptographic communication, this way using light sensor is much cheaper to make and easier for deployment.

In accordance with the invention, another embodiment of method to verify financial card transaction is to use a RF emitter adapter connected to internal bus or I/O bus of a computer, which, once receiving a control signal from the bus, set forth a RF signal having encoded thereon at least an identification associated to a financial card used for purchase payment. A software application executed by the computer to support the payment may signal the adapter to set forth the RF signal immediately after order with account information of the financial card for payment is transmitted to order server for officially placing the order. Alternatively, the software application may signal the adapter to set forth the RF signal immediately after receiving confirmation of order submission from the order server. Then, the RF signal is received by a mobile communication device (MCD) carried with cardholder when placing the order. The MCD processes the received RF signal to obtain the identification associated with the card. An event record coupled with the identification is then generated by the MCD. The event record at least includes a time data of the time that the RF signal is received by the MCD according to internal clock of the MCD. The event record is preserved in a record list for transaction verification. When the MCD receives a notice regarding to newly occurred activity on account associated with a financial card sent by account sever of card issuer, which is coupled with card processing server, the MCD processes the received notice to obtain at least an account identifier associated with the account and a time date of the time that the request of noticed activity is received by the processing server according to internal clock of the server. Then, the MCD searches the record list to find a match between the notice with an event record of the record list that both of them have substantially the same time data regarding to occurring times of receiving the RF signal and receiving the request of notice activity. Additional information such as GPS location of the MCD, store location, or transaction amount may be used accordingly as secondary evidence to further enhance accuracy of matching. The MCD responds to the account server or notifies cardholder accordingly upon matching result after searching of match is finished. It is preferred that cardholder is only notified when a match is not established. Accordingly, the embodiment of the method is especially useful for online order using a financial card for payment, in which, the order server is an online order server communicating with the computer through internet, the software application may be a web browser application or the like, and the computer having the RF emitter adapter connected may be a personal desktop computer, a notebook computer, a tablet computer or other computer-like device capable of performing online order and the RF emitter adapter may be a circuitry built on computer motherboard or the like, an IC chip placed on computer motherboard or the like, or a detachable device inserted on I/O bus either internally or externally. For online order, Accordingly, the embodiment of the method is also useful for point-of-sale transaction using a self checkout station, in which the order server is merchant server to handle point of sale and the self checkout station embodies a computer with display that, in use, has the RF emitter adapter connected thereto.

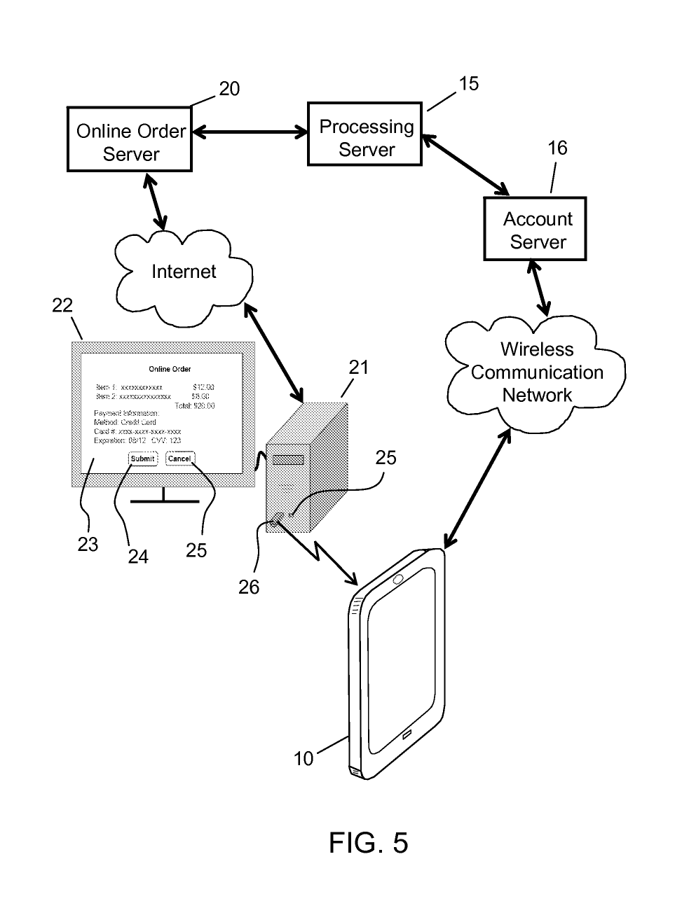

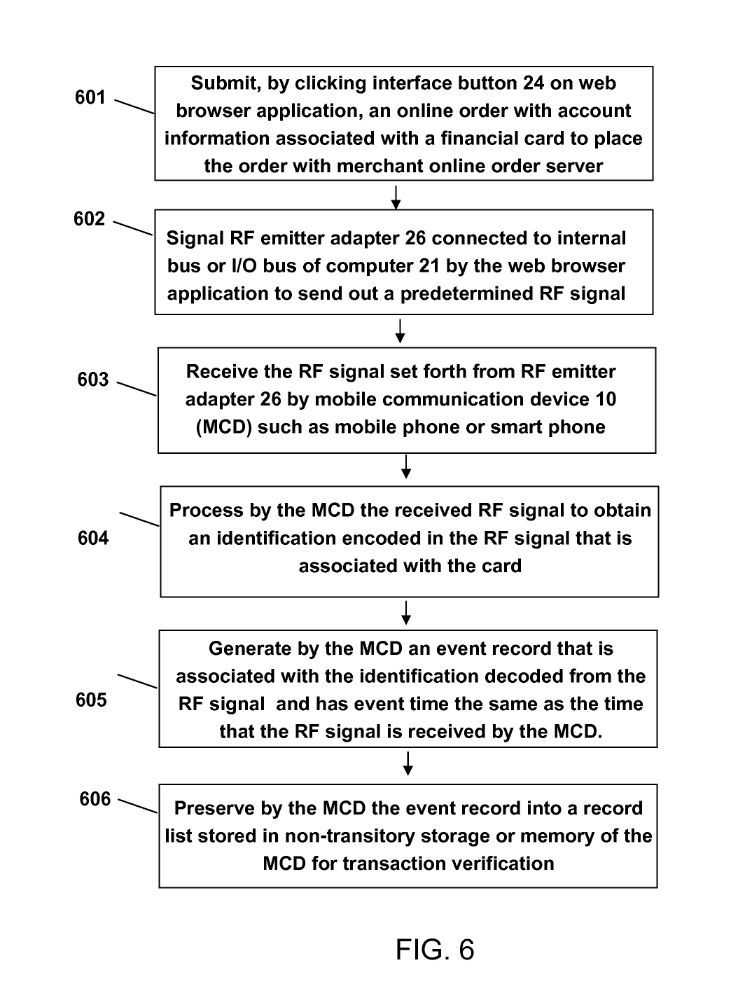

In accordance with the invention, an system to carry on the immediately above embodiment of method to verify financial card transaction is illustratively shown in FIG. 5, and, portion of the embodiment of the method for event record generation is better recognized by referring to process flowchart illustratively given in FIG. 6.

According to FIG. 5, a computer 21 having a display 22 is in use for placing online order with online order server 20 through internet. A RF emitter adapter 26 is connected to one of external ports 25 of I/O bus of computer 21, for example a USB port. As aforementioned, RF emitter adapter may be present inside the computer with, if necessary, an antenna placed elsewhere for RF emission. Way to connect RF emitter adapter with the computer won't affect working manner of the embodiment and is viewed functionally equal to the way illustratively shown in the drawing. Typically, online shopper or user, in this situation cardholder or card user authorized by cardholder, uses web browser application executed by the computer to surf online store website of merchant to look for items to buy. The items to be ordered are placed in online shopping cart. When online shopper decides to check out, he or she is guided following check out procedure to verify a variety of issues before finally placing the order. The online order will be formally submitted if online shopper finally gives permission to do so. This online order submission step is normally carried on by the web browser application to display on display screen 23 important information regarding to the order for review and an interface button 24 for user to give permission. An interface button 25 for user not to give permission may be provided as well. The interface button can be any type of interface input device that is display on display screen for user to act upon as an indication to use its intended operation. If online shopper chooses to use a financial card to pay the order, account information associated with the financial card is inputted into the important information or has been provided in previous checkout step. After reviewing related information correct, if online shopper decides to proceed, he or she clicks interface button 24 with computer mouse, trackball, touch panel or other computer input device to agree to formally place the online order. According to step 601 in FIG. 6, once the interface button is clicked to formally place the order, the online order with account information associated with the financial card is submitted to the online order server to process. The online order server submits payment authorization to processing server 15. The processing server communicates with account server 16 that manages account associated with the financial card to fulfill processing the payment transaction. The online order server may immediately reply the computer to confirm receiving the online order or send confirmation of online order after receiving approval of the payment request from the processing server. When the web browser application supporting the online order placement receives clicking on the interface button to indicate placing the online order, the web browser transmits online order with account information associated with the financial card for payment to the online order server. According to step 602 in FIG. 6, once the transmission to place online order is completed, the web browser sends control signal through internal bus or I/O bus of the computer to the RF emitter adapter to send out a RF signal. The RF signal has encoded thereon at least an identification associated with the financial card. It is to be understood the identification associated with the financial card may be specific for card-not-present transaction of the financial card or even more specific related to the adapter in use. The identification may be stored in unchangeable form on the adapter, which, once set, is not intended to be changed for routine operation. Or, the identification may be able to be set according to the financial card prior to the submission by computer software application through connection bus. Or, the adapter may have a plurality of identifications stored in unchangeable form, each identification associated to a specific financial card, and the web browser application, without having to know the identification, can indicate which identification should be encoded upon the RF signal by the adapter prior to setting forth thereof, thus not exposing the identification to any computer application. According to step 603 in FIG. 6, the RF signal set forth by the RF emitter adapter is received by mobile communication device 10 (MCD) carried with online shopper who is cardholder of the financial card or card user authorized by the cardholder. According to step 604 in FIG. 6, the received RF signal is processed by the MCD to obtain the identification associated with the financial card. If other information is encoded upon the RF signal, it is obtained as well. The MCD also determines the time that the RF signal is received, through either hardware path or software path. According to step 605 in FIG. 6, an event record coupled with the identification is generated by the MCD. The event record at least includes a time date of the time that the MCD receives the RF signal according to internal clock of the MCD. According to step 606 in FIG. 6, the event record is then preserved into a record list, which may be stored in non-transitory storage or memory of the MCD, for transaction verification.

In accordance with the invention, the above described portion of the method to verify financial card transaction, which is illustratively given as from step 601 to step 606 in FIG. 6, constitutes the event record generation of the method. The event record generation of the method of the embodiment is similar as the steps illustratively given in FIG. 2, except the steps to set forth the RF signal. The rest steps to complete the process of the embodiment is the same as corresponding steps of the process of the embodiment in accordance with illustrative showing in FIG. 1 and illustrative given in FIG. 3. More specifically, the event-activity matching of the method is the same as that of the method of the previous embodiment, which is illustratively given as from step 301 to step 306 in drawing 3.

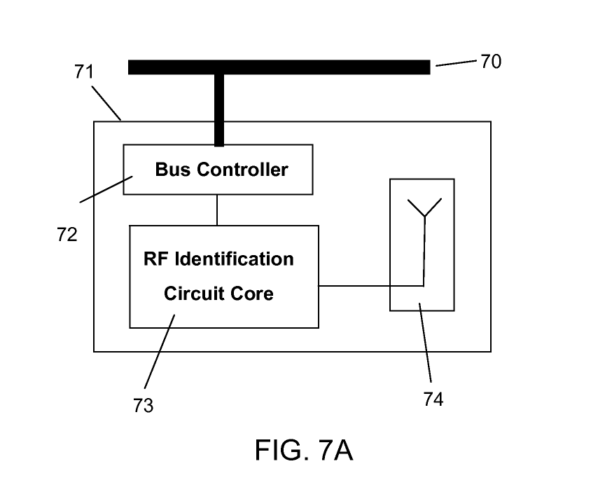

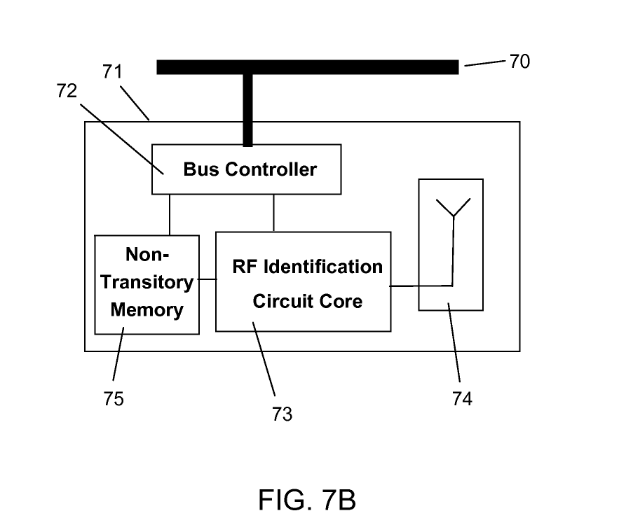

FIG. 7A illustratively gives a possible circuit design for RF emitter adapter 26. According to the drawing, circuit design 71 of the RF emitter adapter comprises a bus controller 71, a RF identification circuit core 73 and an antenna 74 for RF emission. Antenna 74 is connected to circuit core 73. Circuit core 73 has storage for the identification associated with the financial card for payment transaction. Circuit core 73 is connected to bus controller 72 and work at certain predetermined way according to control of bus controller 72. Bus controller 72, when the adapter is in use, is connected to bus 70 which may be internal bus or I/O bus of the computer having the adapter installed. Bus 70 can be one of a variety of buses available for communication with processor of the computer, for example, PCI bus, USB bus, and so on. In operation, bus controller 72 processes communication with the processor and acts accordingly upon control signal received from the processor. When bus controller 72 receives a control signal from bus 70 indicating to send out a RF signal, it will activate RF identification circuit core 73 to set forth a RF signal in a predetermined way. Bus controller 72 may perform as an intermediate to allow the processor modifying the way that the RF signal is sent out if such capability is supported by circuit core 73.

FIG. 7B illustratively gives another possible circuit design for RF emitter adapter 26. According to the drawing, circuit design 71 of the RF emitter adapter comprises bus controller 71, RF identification circuit core 73, antenna 74 for RF emission and a non-transitory memory 75. Memory 75 is connected to bus controller 72 for read/write access of data stored thereon. Memory 75 is also connected with circuit core 73 for primitive read access of data stored thereon. Memory 75 allows data received from the processor through bus 70 to be stored for later access by circuit core 73. When circuit core 73 is activated by bus controller 72 upon receiving corresponding control signal, core circuit may retrieve data from memory 75 and has the data encoded on emitted RF signal. Thus, it permits the web browser application to send additional data regarding to transaction through the RF signal, such as transaction amount, online store code, and so on. If identification associated with financial card is stored on memory 75, which is then retrieved by circuit core 73 to set forth the RF signal, existence of memory 75 on the adapter may also allow cardholder to store and manage identifications associated with financial cards as many as needed and modify those according to own preference as often as necessary. When identification on the adapter is modified by cardholder, its corresponding data on cardholder's mobile communication device should be updated accordingly.

In accordance with the invention, another embodiment of method to verify financial card transaction is to generate and show on display screen by a software application executed by a computer for supporting ordering a data encoded pattern having encoded thereon at least an identification associated with a financial card used for payment of an order and a time date of the time that the order with account information of the financial card is transmitted or is to be transmitted to order server for officially placing the order. An image of the displayed data encoded pattern is then captured by a mobile communication device (MCD) using onboard camera. The MCD processes the captured image of the data encoded pattern to obtain at least the identification and the time date. Then, the MCD generates an event record coupled with the identification that at least includes the time data. The event record is preserved in a record list for transaction verification. When the MCD receives a notice regarding to newly occurred activity on account associated with a financial card sent by account sever of card issuer, which is coupled with card processing server, the MCD processes the received notice to obtain at least an account identifier associated with the account and a time date of the time that the request of noticed activity is received by the processing server according to internal clock of the server. Then, the MCD searches the record list to find a match between the notice with an event record of the record list that both of them have substantially the same time data regarding to occurring times of receiving the RF signal and receiving the request of notice activity. Additional information such as GPS location of the MCD, store location, or transaction amount may be used accordingly as secondary evidence to further enhance accuracy of matching. The MCD responds to the account server or notifies cardholder accordingly upon matching result after searching of match is finished. It is preferred that cardholder is only notified when a match is not established. Accordingly, the embodiment of the method is especially useful for online order using a financial card for payment, in which, the order server is an online order server communicating with the computer through internet, the software application may be a web browser application or the like, and the computer executing the software application may be a personal desktop computer, a notebook computer, a tablet computer or other computer-like device capable of performing online order. Accordingly, the embodiment of the method is also useful for point-of-sale transaction using a self checkout station, in which the order server is merchant server to handle point of sale and the self checkout station embodies a computer with display that, in use, generates and display the data encode pattern for image capturing.

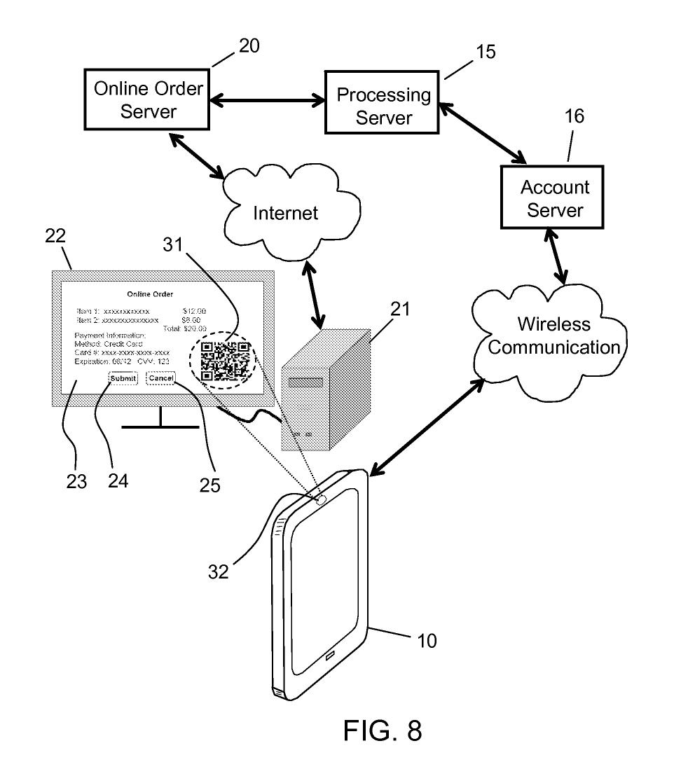

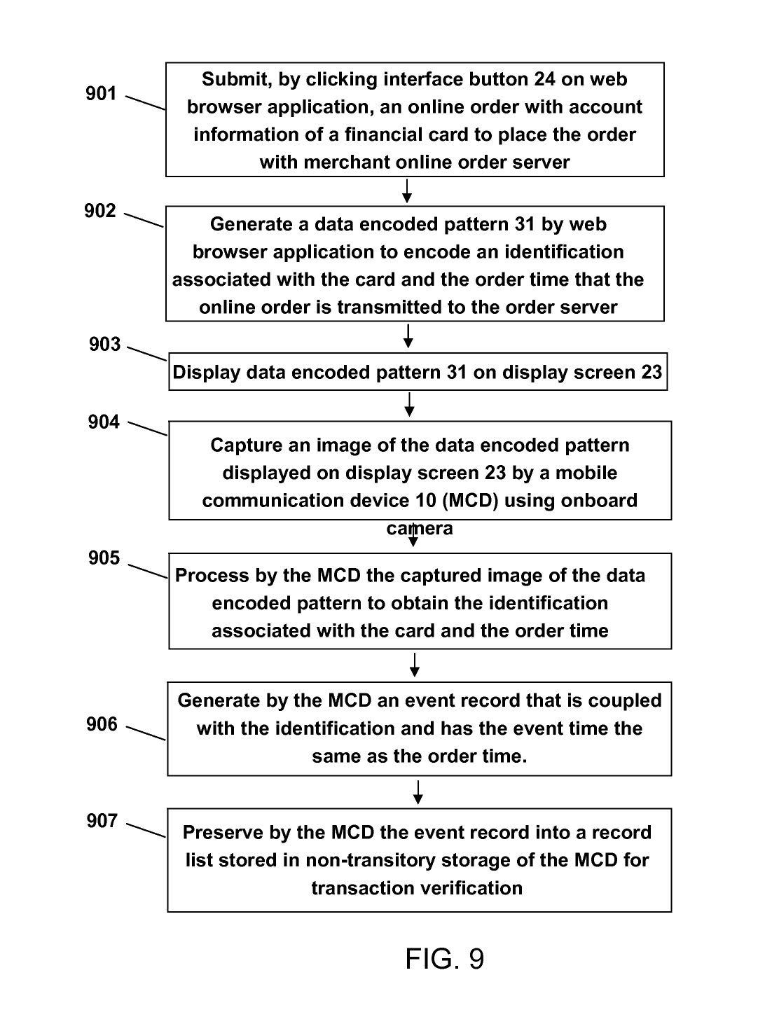

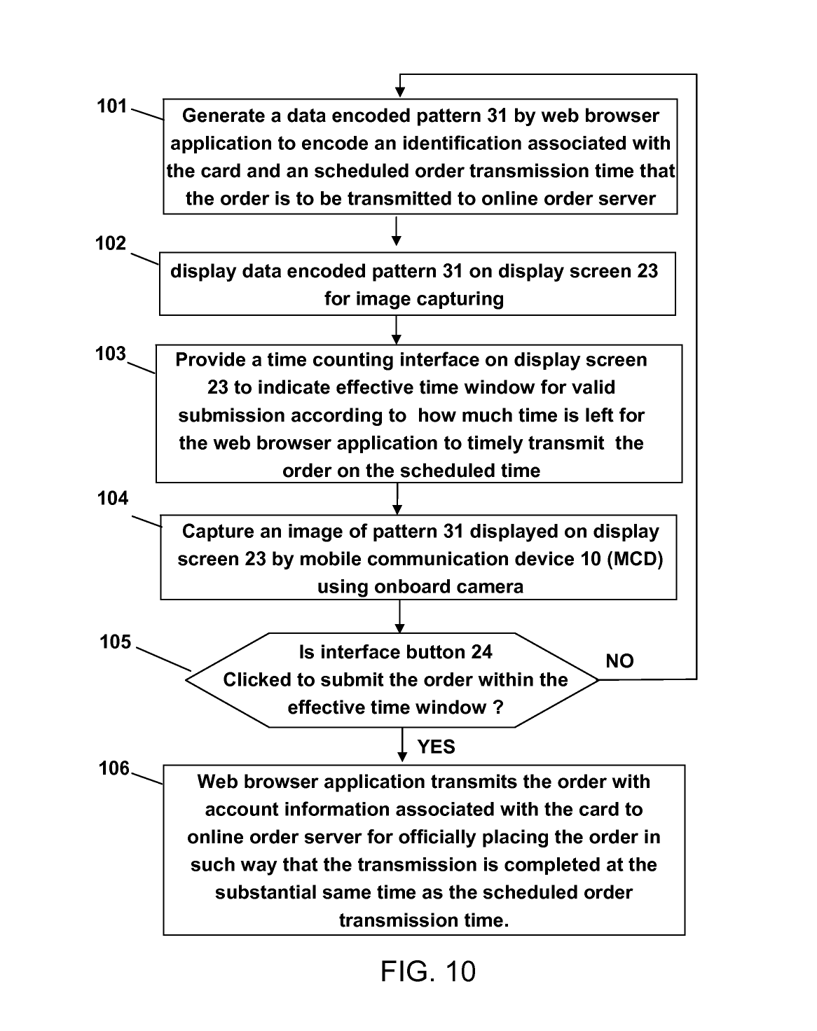

In accordance with the invention, an system to carry on the immediately above embodiment of method to verify financial card transaction is illustratively shown in FIG. 8, and, portion of the embodiment of the method for event record generation is better recognized by referring to process flowchart illustratively given in FIG. 9 and FIG. 10. According to FIG. 8, computer 21 having display 22 is in use for placing online order with online order server 20 through internet. Typically, online shopper, in this situation cardholder or card user authorized by cardholder, uses web browser application executed by the computer to surf online store website of merchant to look for items to buy. The items to be ordered are placed in online shopping cart. When online shopper decides to check out, he or she is guided following check out procedure to verify a variety of issues before finally placing the order. The online order will be formally submitted if online shopper finally gives permission to do so. This online order submission step is normally carried on by the web browser application to display on display screen 23 important information regarding to the order for review and interface button 24 for user to give permission. Interface button 25 for user not to give permission may be provided as well. If online shopper chooses to use a financial card to pay the order, account information associated with the financial card is inputted into the important information or has been provided in previous checkout step. After reviewing related information correct, if online shopper decides to proceed, he or she clicks interface button 24 with computer mouse to agree to formally place the online order.

The embodiment essentially relies on image capturing and processing of a data encoded pattern 31 for a mobile communication device 10 (MCD) to obtain crucial transaction related information from the computer placing online order. However, at the online order submission step, the actual transmission time to fulfill transmission of online order is unknown yet. In order for the transmission time to be encoded in data encoded pattern 31 for image capturing by the MCD, one way is to generate the data encoded pattern after web browser application handling the online order fulfills transmission of online order. According to step 901 in FIG. 9, once interface button 24 is clicked to formally place the order, the online order with account information associated with the financial card is submitted to the online order server to process. The online order server submits payment authorization to processing server 15. The processing server communicates with account server 16 that manages account associated with the financial card to fulfill processing the payment transaction. The online order server may immediately reply the computer to confirm receiving the online order or send confirmation of online order after receiving approval of the payment request from the processing server. When the web browser application supporting the online order placement receives clicking on the interface button to indicate placing the online order, the web browser transmits online order with account information associated with the financial card for payment to the online order server. According to step 902 in FIG. 9, once the transmission to place online order is completed, the web browser generates data encoded pattern 31 having encoded thereon at least an identification associated with the financial card and an order transmission time the same as the time that the transmission to place online order is fulfilled according to internal clock of the computer. It is to be understood the identification associated with the financial card may be specific for the purpose herein. The identification may be either stored in advance in computer storage or network storage or inputted by cardholder through online order interface for the web browser application to use. The identification may also be conveyed to the web browser application by the MCD through any available communication means, such as local wireless network communication, near field communication, Bluetooth communication, image capturing, or the like. According to step 903 in FIG. 9, data encoded pattern 31 is then displayed on display screen 23 by the web browser application. According to step 904 in FIG. 9, an image of the displayed data encoded pattern is captured by mobile communication device 10 (MCD) using its onboard camera. According to step 905 in FIG. 9, the captured image of the data encoded pattern is then processed to obtain the identification associated with the financial card and the order transmission time encoded in the pattern. If additional information is encoded in the pattern, it is obtained as well. According to step 906 in FIG. 9, an event record coupled with the identification is generated by the MCD. The event record at least includes a time data of event time the same as or timely equivalent to the order transmission time. The time data of the event record is to be used as primary evidence for later event-activity matching. According to step 907, the event record is preserved by the MCD in a record list for transaction verification. The record list may be stored in non-transitory storage, such as non-transitory memory or magnetic hard drive, of the MCD. By now, the event record generation of the method is accomplished. However, it is possible that, if the image capturing is not done promptly, the MCD may receive a notice of activity regarding to the transaction from account sever before an event record related to the transaction is created, thus causing alert of suspicious account activity. To avoid the issue, the image capturing should be performed as quick as possible in order to get an event record related to the transaction created in time by the MCD.

Alternatively, according to the embodiment, in order for the transmission time to be encoded in data encoded pattern 31 for image capturing by the MCD, another way is to generate the data encoded pattern to encode an scheduled order transmission time that is determined by the web browser application upon giving a reasonable time period for cardholder to decide whether to officially place the order and a maximum time cost for the application to fulfill transmission of the order. In order to have actual transmission completed on the scheduled time, the transmission may be divided into several portions and have the last portion finished as close to the scheduled time as allowable. Implementation of the way is illustratively given in the flow chat in FIG. 10. According to step 101 in FIG. 10, a data encoded pattern 31 is generated by web browser application supporting online order. The data encoded pattern has encoded thereon at least an identification associated with the financial card used for online order payment and an scheduled order transmission time that the order is scheduled to be transmitted to online order server 20 upon permission given by online shopper. Then, according to step 102 in FIG. 10, the data encoded pattern is display on display screen 23 for image capturing in together with other important information presented on the screen for online shopper to make decision to formally place the order. According to step 104 in FIG. 10, an image of the data encoded pattern as displayed is captured by mobile communication device 10 (MCD) using on board camera. Once the image is captured, the MCD generates an event record of the transaction in its record list according to steps illustratively given as from step 905 to step 907 in FIG. 9. After capturing the image, interface button 24 should be clicked within a certain time period in order to proceed to officially place the order. If it is clicked too late, the web browser application handling the order submission may not be able to timely complete transmission of the order through internet to online order server 20 approximately on the scheduled order transmission time, thus rendering the capture image no longer providing valid data. To avoid the problem, according to step 103 in FIG. 10, a time counting interface or interface timer (not shown) prompting online shopper the time left for a click of valid submission may be provided on display screen 23 in together with the data encoded pattern. The time counting interface indicates effective time window for valid submission according to how much time is left for the web browser application to timely transmit the order on the scheduled order transmission time. The time counting interface may present data either in time counting down or in time counting up. After capturing the image, online shopper should click interface button 24 within the time window indicated by the time counting interface to give permission to place the order. If online shopper fails to do so within the time window, a new data encoded pattern having encoded thereon a new scheduled order transmission time is generated and replaced the expired data encoded pattern. When the new data encoded pattern is displayed, the time window is reset accordingly. According to step 105 in FIG. 10, when a click on interface button 24 giving permission to submit the order is received, the web browser application checks whether the click occurs within the effective time window. If affirmative, according to step 106 in FIG. 10, the web browser application transmits the order to online order server 20 for officially placing the order in such way that the transmission is fulfilled approximately on the same time as the scheduled order transmission time. If negative, the web browser application will repeat steps from step 101. A new data encoded pattern with a new scheduled transmission time encoded thereon is generated and displayed, and, the time window is reset. The new data encoded pattern should be captured by the MCD before proceeding to place the order. The negative outcome may be caused by two different actions of online shopper that, one is the click occurs too late for the web browser application to keep the scheduled transmission time valid, and the other is that the effective time window elapses without giving the click. No matter what causes the negative outcome, it is reset to start from step 101 again.

So far, the event record generation of the method of the embodiment is accomplished. The rest steps to complete the process of the embodiment is the same as corresponding steps of the process of the embodiment in accordance with illustrative showing in FIG. 1 and illustrative given in FIG. 3. More specifically, the event-activity matching of the method is the same as that of the method of the previous first embodiment, which is illustratively given as from step 301 to step 306 in drawing 3.

Throughout the disclosure, term “ web browser application” refers to any software application acting as an interface between computer user and internet to support at least online ordering.

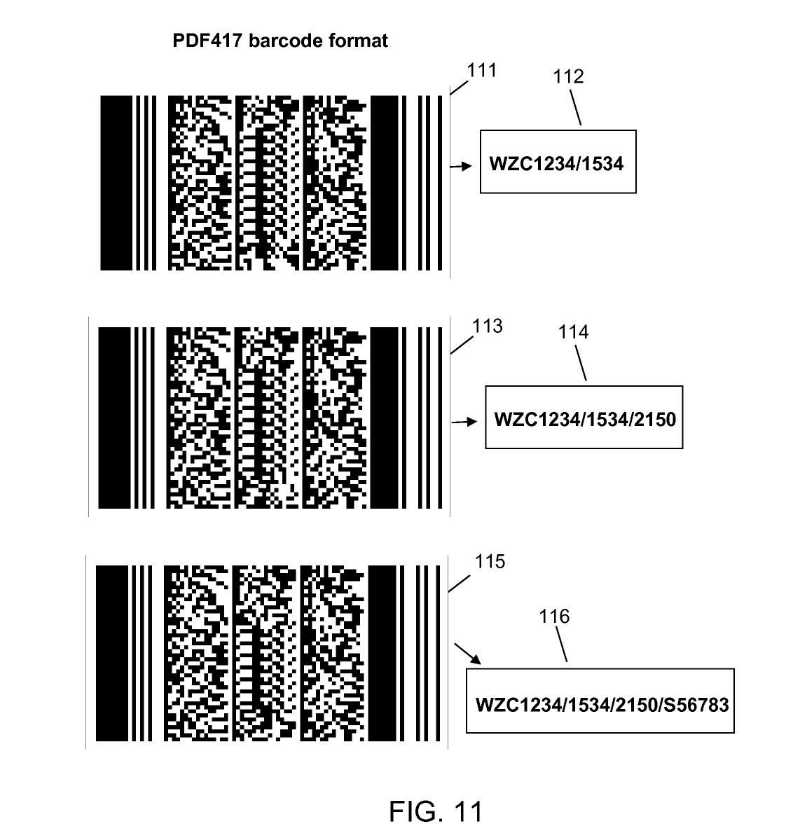

FIG. 11 gives several examples of possible data encoded pattern useful for the embodiment. In the drawing, a exemplary data encoded pattern 111, made of PDF 417 barcode format, has encoded thereon exemplary data 112 of content “WZC1234/1534”, which represents “Wei Zhang's Card No. 1234” and time “15:34”. Another exemplary data encoded pattern 113, made of PDF 417 barcode format, has encoded thereon exemplary data 114 of content “WZC1234/1534/2150”, which represents “Wei Zhang's Card No. 1234”, time “15:34”, and amount $21.50″. Another exemplary data encoded pattern 115, made of PDF 417 barcode format, has encoded thereon exemplary data 116 of content “WZC1234/1534/2150/S56783”, which represents “Wei Zhang (WZ)'s Card No. 1234”, time “15:34”, amount “$21.50”, and store ID “S56783”.

Above descriptions about the embodiment illustratively presents detailed process and system for online ordering. It is to be understood that ordinary skilled person in related art can use the teaching of the above description to implement the embodiment for applications other than online ordering in accordance with the invention. For example, for point-of-sale application, the computer used in the above description may be replaced with a self automatic checkout machine communicating with store order server through store-wide network. The self automatic checkout machine contains a computer executing a software application to support customer checkout procedure. The software application works similarly as the web browser application in the above description, but transmitting order to store order server through store-wide network.

In accordance with the invention, it is to be understood that time determination by software application according to internal clock of a computer can never be very accurate. So, when time relied upon to decide when an event of transaction occurs or an account activity occurs is referred in the disclosure, it means the time is approximately or effectively equivalent to the exact time of the same, which further means best effort to determine the time by software application and, if applicable, hardware to support the effort. Furthermore, term “internal clock” of a computer, a mobile communication device or a server means clock time determination mechanism existing inside thereof, which can be in any form of existence. It is commonly known that internal clock of a mobile communication device may rely on constantly updating from an external time source such as clock signal through wireless communication network or GPS signal. It also commonly known that internal clock thereof may be calibrated periodically with external time reference to keep it as accurate as possible.

In overall, in accordance with the invention, method to verify financial card transaction and system to carry on the method, including the embodiments disclosed in the disclosure, have following advantageous characteristics: 1. Transaction verification primitively relies on occurring time of transaction event and occurring time of transaction authorization request, which are respectively determined according to internal time source of the MCD or the computer for placing the order and internal time source of server fulfilling the transaction. These time sources are not likely to be manipulated by a card fraud criminal, thus very reliable in term of security. 2. Although transaction amount or store code may be used as secondary evidence to enhance accuracy of transaction verification, it is not relied upon to establish an event-activity match for transaction verification, thus not necessary to be present in event record generation. Thus, cardholder's privacy and account safety is retained because transaction amount or store code of transaction is much more sensitive to privacy and account safety than occurring time of transaction. Furthermore, not having transaction amount or store code stored in the MCD relieves cardholder's concern that it may leak out if the MCD is lost or compromised; Furthermore, activity notice sent from account server through wireless communication network does not have to include transaction amount or store code, thus eliminating possible interception thereof. Therefore, using occurring time instead of transaction amount or store code for transaction verification does protect cardholder's privacy and retains account safety. 3. device used to signalize event record generation and the MCD to manage event record and verification are all within cardholder's control range, thus making the method more trustable to cardholder. 4. Merchant side does not get involved in the transaction verification. It is just like doing an ordinary financial card transaction for merchant side. Thus, there is very little or even zero cost on merchant side to implement the method. For example, for financial card with RF identification circuitry, merchant side just needs to install a card reader to support proximity activation of the RF identification circuitry. For online ordering either using RF emitter adapter or image capturing of data encoded pattern, merchant side does not need to take any change on its website and server. 5. Transaction verification using the method only matters cardholder and card issuer, not merchant side. Its using and outcome is up to agreement between cardholder and card issuer. Thus, cardholder may be given more freedom to select when and how to carry on the transaction verification. Therefore, it is more willful for cardholder to accept the transaction verification.

It should be understood that embodiments disclosed are only a few examples of possible implementations of the invention and their teachings may be used by ordinary skilled in related art to modify the embodiments or derive from the embodiments to form embodiment appearing not similar as the embodiments but still utilizing true merit and teaching spirit of the invention. Therefore, if any, the modification or derivation is still within the scope of the invention and all related rights are reserved.

I claim:

1. A method comprising:
receiving by a mobile communication device a RF signal emitted from a RF identification circuitry in proximity to the mobile communication device, wherein said RF identification circuitry is activated to set forth said RF signal at substantially the same time as a payment transaction is initialized and said RF signal has encoded thereon at least an identification associated with a financial account with which an account information used to initialize the payment transaction is associated;
processing by the mobile communication device said RF signal to obtain said identification;
determining by the mobile communication device the receiving time that said RF signal is received according to internal clock of the device; and,
generating by the mobile communication device an event record coupled with said identification, wherein said event record at least includes an event time data corresponding to the receiving time.

2. The method in according with claim 1 further comprising the step of:
preserving by the mobile communication device said event record generated in the above step of said generating into a record list.

3. The method in accordance with claim 2 further comprising:
receiving by the mobile communication device an activity notice regarding to a newly occurred account activity associated with a financial account, wherein said activity notice sent by an account server associated with the financial account comprises an account identifier associated with the financial account and an activity time data of the time substantially same as the time that the account activity is initialized; and,
searching by the mobile communication device the record list for an event record associated with the same financial account as the account identifier to make a match between the event record and said activity notice, wherein said match is made only if the event time data of the event record is substantially the same as the activity time data of said activity notice.

4. The method in accordance with claim 3 further comprising the step of:
notifying the account server by the mobile communication device through wireless communication network searching result of the step of said searching, wherein said searching result indicates whether said match is made or not.

5. The method in accordance with claim 1 further comprising the step, prior to the step of said receiving, of,
setting forth said RF signal by a financial card embodying said RF identification circuitry upon activation signal received from a card reader, on which said card is applied to initialize the payment transaction.

6. The method in accordance with claim 5 wherein said financial card comprises:
said RF identification circuitry; and,
a light sensor coupled with said RF identification circuitry in such way that said RF identification circuitry is disabled if said light sensor has no light incidence detected thereupon.

7. The method in accordance with claim 6 wherein said financial card further comprises:
a second light sensor coupled with said RF identification circuitry in such way that said RF identification circuitry is disabled if said second light sensor has light incidence detected thereupon.

8. The method in accordance with claim 5 wherein said financial card comprises:
a magnetic strip having stored thereon said account information for using said financial card on the card reader;
said RF identification circuitry; and,
a loop coil substantially overlapping with said magnetic strip, wherein said loop coil is connected to said RF identification circuitry in order to send an activation signal into said RF identification circuitry;
whereby, in use, said loop coil magnetically coupled with the card reader receives said activation signal from the card reader and passes said activation signal into said RF identification circuitry.

9. The method in accordance with claim 8 wherein said financial card further comprises a light sensor coupled with said RF identification circuitry in such way that said RF identification circuitry is disabled if said light sensor has no light incidence detected thereupon detected and is enabled if said light sensor has light incidence detected thereupon.

10. The method in accordance with claim 1 further comprising the step, prior to the step of said obtaining, of,
setting forth said RF signal by a RF emitter adapter embodying said RF identification circuitry upon control signal received from a computer bus on which said adapter is connected.

11. A method comprising:
capturing by a mobile communication device using its onboard camera an image of a data encoded pattern displayed on a display screen in couple with placing an order, wherein the data encoded pattern has encoded thereon at least an identification associated with a financial account, with which an account information used for payment of the order is associated, and an order transmission time which is substantially the same time as the order is transmitted to an order server;
processing by the mobile communication device said image of said data encoded pattern to obtain the identification and said order transmission time; and,
generating by the mobile communication device an event record coupled with said identification, said event record at least includes an event time data corresponding to said order transmission time.

12. The method in accordance with claim 11 further comprising the step of:
preserving by the mobile communication device said event record generated in the above step of said generating into a record list.

13. The method in accordance with claim 12 further comprising:
receiving by the mobile communication device an activity notice regarding to a newly occurred account activity associated with a financial account, wherein said activity notice sent by an account server associated with the financial account comprises an account identifier associated with the financial account and an activity time data of the time substantially same as the time that the account activity is initialized; and,
searching by the mobile communication device the record list for an event record associated with the same financial account as the account identifier to make a match between the event record and said activity notice, wherein said match is made only if the event time data of the event record is substantially the same as the activity time data of said activity notice.

14. The method in accordance with claim 13 further comprising the step of,
notifying the account server by the mobile communication device through wireless communication network searching result of the step of said searching, wherein said searching result indicates whether said match is made or not.

15. The method in accordance with claim 11 further comprising the step, prior to the step of said capturing, of,
generating, by a software application executed by a computer to support placing said order, said data encoded pattern with the order transmission time which is determined by the computer according to its internal clock after the order is transmitted to the order server, and displaying said data encoded pattern on a display screen coupled with the computer by the software application.

16. The method in accordance with claim 11 further comprising the step, prior to the step of said capturing, of,
generating, by a software application executed by a computer to support placing said order, said data encoded pattern with the order transmission time which is a predetermined time scheduled by the software application according to internal clock of the computer to fulfill order transmission, and displaying said data encoded pattern on a display screen coupled with the computer by the software application.

17. The method in accordance with claim 11 further comprising the steps, prior to the step of said capturing, of:
generating, by a software application executed by a computer to support placing said order, said data encoded pattern with the order transmission time which is a predetermined time scheduled by the software application according to internal clock of the computer to fulfill order transmission, and displaying said data encoded pattern on a display screen coupled with the computer by the software application; and,
displaying, by the software application, a time counting interface on the display screen to indicate an effective time window according to how much time is left in order for the software application to timely transmit the order on said predetermined time.

18. The method in accordance with claim 17 further comprising the step, after the step of said displaying, of,
as soon as permission to place the order is not received by the software application through computer interface within said effective time window, repeating the step of said generating and displaying said data encoded pattern.

19. A method comprising:
displaying, by a software application executed by a computer in use for placing an order with an order server, a computer interface on a display screen coupled with the computer, wherein said computer interface comprises order information of the order and payment information to be used for payment of the order and an interface input device which is used to receive permission to place the order through clicking thereof by a computer pointing device;
receiving permission to place the order from said interface input device by the software application;
transmitting by the software application the order coupled with the payment information to the order server for placing the order; and,
sending by the software application a control signal to a RF emitter adapter, connected to a bus of the computer, through the bus for said adapter to set forth a predetermined RF signal emitted from a RF identification circuitry embodied by said adapter.

20. The method in accordance with claim 19 wherein said RF emitter adapter comprises:
a bus controller for computer communication interface; and,
said RF identification circuitry connected to said bus controller;
whereby, in use, said bus controller is connected to the bus of the computer and, upon receiving said control signal, said bus controller activates said RF identification circuitry to emit said predetermined RF signal.
